(19) United States
(12) Patent Application Publication
(10) Pub. No.: US 2016/0292825 A1
(43) Pub. Date: Oct. 6, 2016

(54) SYSTEM AND METHOD TO REFINE IMAGE DATA

(71) Applicant: QUALCOMM Incorporated, San Diego, CA (US)

(72) Inventors: Ramin Rezaiifar, Del Mar, CA (US); William Edward Mantzel, San Diego, CA (US)

(21) Appl. No.: 14/847,931

(22) Filed: Sep. 8, 2015

Related U.S. Application Data
(60) Provisional application No. 62/143,671, filed on Apr. 6, 2015.

(51) Int. Cl. G06T 5/00; G06K 9/62; G06F 17/30; G06K 9/52; G06K 9/46

(52) U.S. Cl. CPC G06T 5/00; G06K 9/52; G06K 9/4661; G06F 17/3028; G06K 9/6218

(57) ABSTRACT

A method of image processing includes receiving data representative of image at a computing device. The method further includes generating a first modified image by changing a luma channel of the image according to a first function. The method further includes generating a second modified image by changing the luma channel of the image according to a second function. The method further includes determining weights based on values of pixels in the image. The method further includes generating a refined image by combining first pixel values of the first modified image and second pixel values of the second modified image based on the weights.

### CROSS-REFERENCE TO RELATED APPLICATIONS

The present application claims priority to and the benefit of U.S. Provisional Patent Application No. 62/143,671 filed Apr. 6, 2015, the content of which is expressly incorporated herein by reference in its entirety.

### FIELD

The present disclosure is generally related to refining image data.

### DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices incorporate image sensors, such as digital still cameras and/or digital video cameras. Images captured by these image sensors may be used by individuals for aesthetic or commemorative reasons or may be used by computer vision systems to detect and/or recognize objects in a scene. Utility of the images captured by the image sensors for individuals or computer vision systems may depend in part on clarity of the images. Various conditions may affect the clarity of the images captured by the image sensors. For example, condensate on a lens of the image sensor or atmospheric conditions, such as fog, rain, smoke, or haze, may adversely affect the clarity of the images.

### SUMMARY

A system and a method for refining image data are disclosed. The image data may be descriptive of an input image and may be refined by generating modified image data descriptive of a plurality of modified images (e.g., a simulated low exposure image and a simulated high exposure image), by determining a weight for each modified image for each pixel of the input image, and by combining pixel values of the modified images based on the weights to generate refined image data. The refined image data may represent a refined version of the input image (e.g., a refined image). For example, the refined image may have enhanced contrast and features (e.g., objects) may be more easily detected in the refined image by humans and computer vision systems as compared to the input image.

In a particular aspect, a method is disclosed. The method includes receiving data representative of image at a computing device. The method further includes generating first modified image by changing a luma channel of the image according to a first function. The method further includes generating a second modified image by changing the luma channel of the image according to a second function. The method further includes determining weights based on values of pixels in the image. The method further includes generating a refined image by combining first pixel values of the first modified image and second pixel values of the second modified image based on the weights.

In another particular aspect, a computer readable storage device stores instructions, that when executed by a processor, cause the processor to perform operations. The operations include receiving data representative of image. The operations further include generating a first modified image by changing a luma channel of the image according to a first function. The operations further include generating a second modified image by changing the luma channel of the image according to a second function. The operations further include determining weights based on values of pixels in the image. The operations further include generating a refined image by combining first pixel values of the first modified image and second pixel values of the second modified image based on the weights.

In another particular aspect, an apparatus is disclosed. The apparatus includes a memory and a processor. The processor is configured to receive data representative of image at a computing device. The processor is further configured to generate a first modified image data by changing a luma channel of the image according to a first function. The processor is further configured to generate a second modified image by changing the luma channel of the image according to a second function. The processor is further configured to determine weights based on values of pixels in the image. The processor is further configured to generate a refined image data by combining first pixel values of the first modified image and second pixel values of the second modified image based on the weights.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a block diagram of a particular illustrative aspect of a system for refining image data;

FIG. 2 is a diagram illustrating generation of a refined image based on an input image;

FIG. 3 is a diagram illustrating generation of functions used to create modified image data;

FIG. 4 is a diagram illustrating generation of weights associated with a pixel in an input image;

FIG. 5 is a flowchart illustrating a method of generating a refined image; and

FIG. 6 is a block diagram of an apparatus used to generate refined image data.

### DETAILED DESCRIPTION

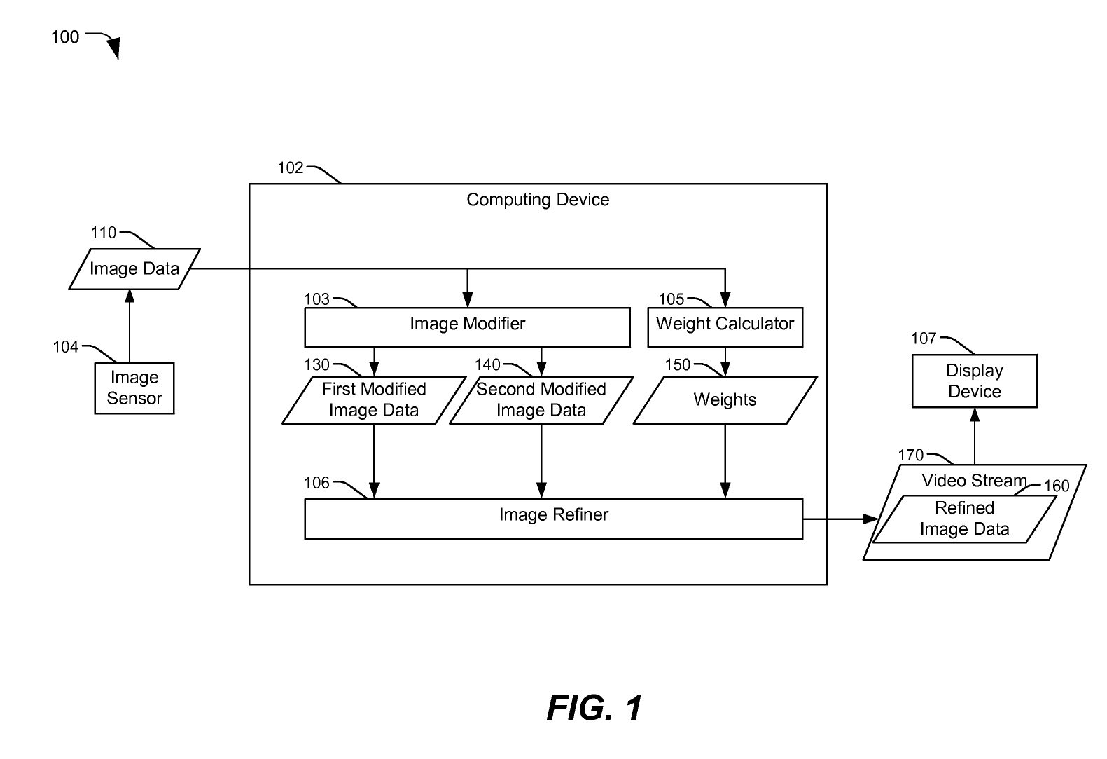

Referring to FIG. 1, a block diagram of a system 100 for refining image data is shown. The system 100 includes a computing device 102. The computing device 102 may correspond to a mobile device, such as a mobile phone, a laptop computer, a tablet computer, a smart watch, etc., or to another computing device, such as a server, a desktop computer, a drone, or a computer system integrated into a vehicle. In the illustrated example, the computing device 102 is in communication with, and may receive image data 110 from, an image sensor 104. The image sensor 104 may correspond to a camera and may be located remotely from the computing device 102. In other examples, the image sensor 104 may be a part of the computing device 102 or may be located in a same housing as the computing device 102. For example, the computing device 102 may correspond to a mobile phone, and the image sensor 104 may correspond to a camera of the mobile phone. In some examples, the computing device 102 may receive the image data 110 from a different source, such as from another computing device or a memory device. In a particular example, the image sensor 104 is configured to generate data representing an image composed of multiple pixels, where values of each pixel are determined by the image sensor 104 using a common configuration setting (e.g., exposure time).

The computing device 102 may include an image modifier 103, a weight calculator 105, and an image refiner 106. The image modifier 103, the weight calculator 105, and the image refiner 106 may correspond to hardware modules of the computing device 102, to software modules executed by one or more processors of the computing device 102, or to a combination of hardware and software modules.

In the illustrated example, the computing device 102 is in communication with a display device 107. The display device 107 may be located remotely from the computing device 102 or may be located in a same housing as the computing device 102. For example, the computing device 102 may correspond to a mobile phone and the display device 107 may correspond to a display device of the mobile phone. In some examples, the computing device 102 may be in communication with a memory device or with another computing device.

In operation, the computing device 102 receives the image data 110. In the illustrated example, the image data 110 is received from the image sensor 104, but the image data 110 may be received from other sources, such as another computing device. For example, the image data 110 may be received as part of an image refining request from another computing device. The image data 110 may be received as part of an input video stream (e.g., the image data 110 may correspond to a frame of the input video stream). The image data 110 may represents one input image. The one input image may be an image of a scene (e.g., an image captured by the image sensor 104). For example, the image data 110 may include one or more values for each of a plurality of pixels. The image data 110 may be used by a display device, such as the display device 107, to activate a plurality of pixels of the display device based on the one or more values for each pixel to display the image of the scene. The one or more values may include a luma channel value (y), a blue chroma channel value (Cb), and a red chroma channel value (Cr). The luma channel value of a pixel may indicate a luminous intensity of light traveling through the pixel. Objects in the scene may be difficult to discern in the input image due to condensate on a lens of the image sensor that captured the input image, atmospheric conditions, such as fog, rain, smoke, or haze, or other conditions that may affect image clarity.

The image modifier 103 may generate first modified image data 130 and second modified image data 140 based on the image data 110. The image modifier 103 may generate the first modified image data 130 by applying a first function to pixel values described by the image data 110 to generate first modified pixel values. For example, the image modifier 103 may apply the first function to each pixel in a luma channel (y channel) described by the image data 110 to generate the first modified image data 130. To illustrate, a function F may receive a pixel value (e.g., a luma channel value) corresponding to a first pixel described by the image data 110 as input and output a new pixel value to be assigned to a second pixel described by the first modified image data 130 that corresponds to the first pixel. The first pixel may correspond to the second pixel based on the first pixel having particular coordinates in the input image and the second pixel having the particular coordinates in the first modified image. Other pixel values associated with the second pixel may be the same as the corresponding values of the first pixel. For example, the function F may be used by the image modifier 103 to generate new luma channel values for pixels described by the first modified image data 130 based on corresponding luma channel values of pixels described by the image data 110. The pixels described by the first modified image data 130 may have the same blue chroma channel and red chroma channel values as the corresponding pixels described by the image data 110. In a particular example, the function F may correspond to a lookup table that maps an input pixel value to an output pixel value. The function F may generally output a pixel value that is lower than an input pixel value. For example, the function F may be used to generate luma channel values for the first modified image data 130 that are lower than luma channel values of the input image data 110. That is, the first modified image data 130 may describe a simulated low exposure image of the scene. Particular areas of the simulated low exposure image corresponding to relatively brighter areas of the input image described by the image data 110 may have increased contrast as compared to the input image. Therefore, objects depicted in the particular areas may be more easily detectable by humans and computer vision systems as compared to objects depicted in the corresponding areas of the input image.

The image modifier 103 may generate the second modified image data 140 by applying a second function to the pixel values described by the image data 110 to generate second modified pixel values. For example, the image modifier 103 may apply the second function to each pixel in the luma channel (y channel) described by the image data 110 to generate the second modified image data 140. To illustrate, a function G may receive a pixel value (e.g., a luma channel value) corresponding to a first pixel described by the image data 110 as input and output a new pixel value to be assigned to a second pixel described by the second modified image data 140 that corresponds to the first pixel. The first pixel may correspond to the second pixel based on the first pixel having particular coordinates in the input image and the second pixel having the particular coordinates in the second modified image. For example, the function G may be used by the image modifier 103 to generate new luma channel values for pixels described by the second modified image data 140 based on corresponding luma channel values of pixels described by the image data 110. The pixels described by the second modified image data 140 may have the same blue chroma channel and red chroma channel values as the corresponding pixels described by the image data 110. In a particular example, the function G may correspond to a lookup table that maps an input pixel value to an output pixel value. The function G may generally output a pixel value that is higher than an input pixel value. For example, the function G may be used to generate luma channel values for the second modified image data 140 that are higher than luma channel values of the input image data 110. That is, the second modified image data 140 may describe a simulated high exposure image of the scene. Particular areas of the simulated high exposure image corresponding to relatively darker areas of the input image described by the image data 110 may have increased contrast as compared to the input image. Therefore, objects depicted in the particular areas may be more easily detectable by humans and computer vision systems as compared to objects depicted in the corresponding areas of the input image.

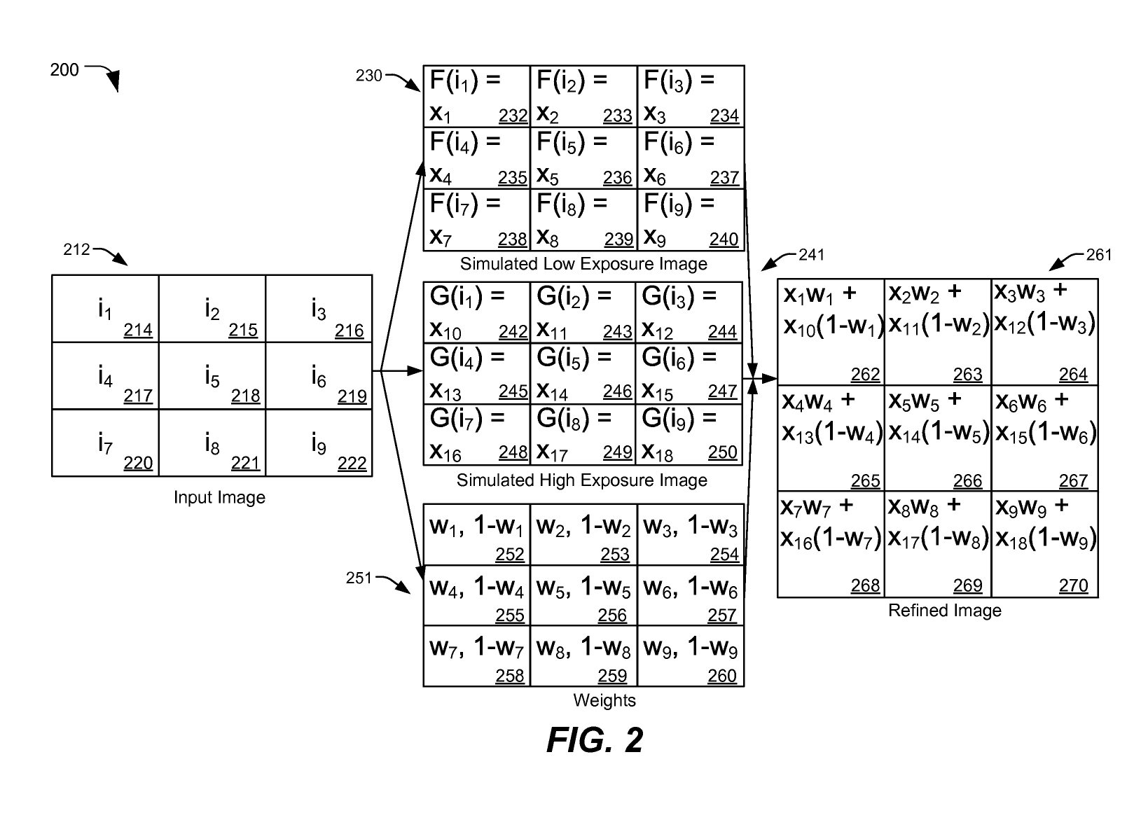

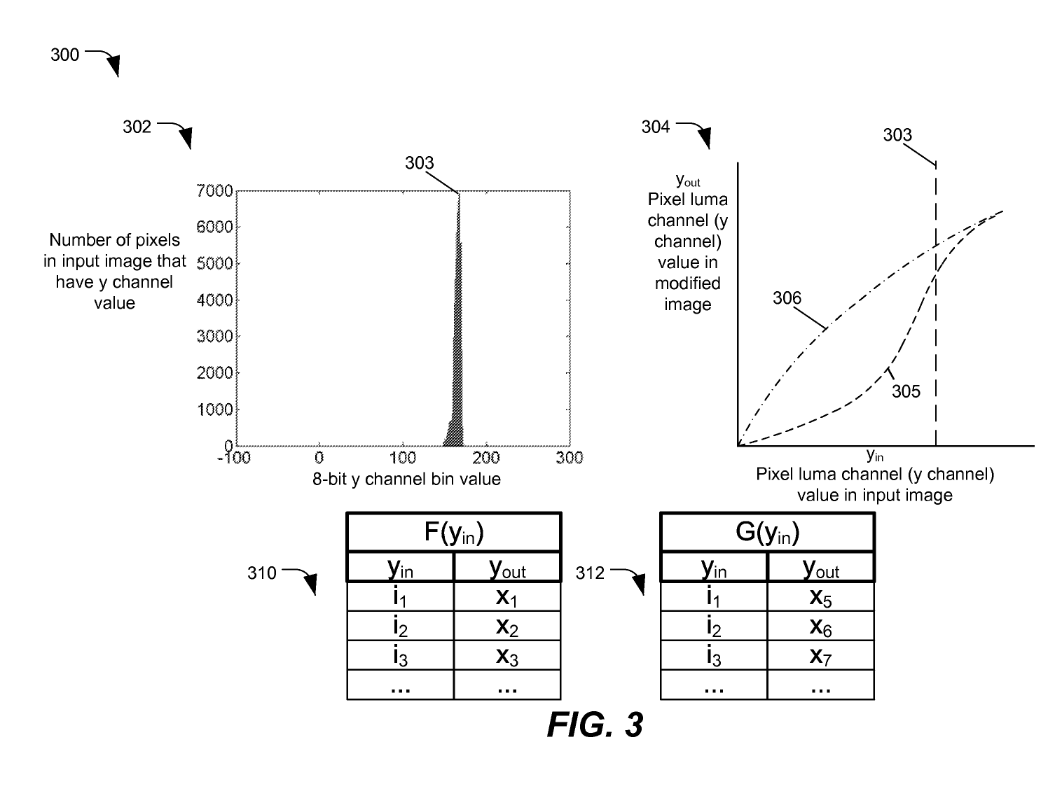

The first and second functions are described in more detail below with reference to FIGS. 2 and 3. While the image modifier 103 is shown generating only two sets of modified image data, it should be noted that, in certain examples, more sets of modified image data may be generated by the image modifier 103.

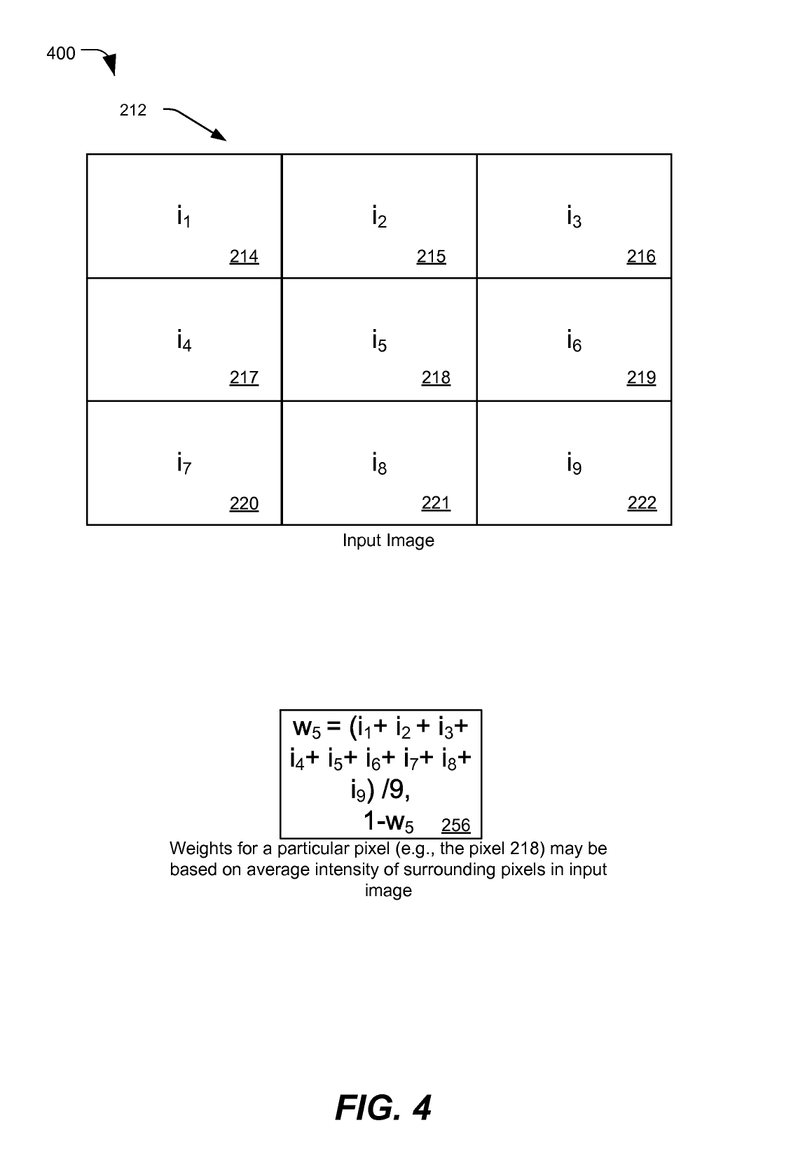

The weight calculator 105 may generate weights 150 based on the pixel values described by the image data 110. The weight calculator 105 may generate a weight corresponding to each pixel described by each of the sets of modified image data generated by the image modifier 103 (e.g., the first modified image data 130 and the second modified image data 140). The sets of modified image data may each describe a number of pixels equal to a number of pixels described by the image data 110. Thus, in the illustrated example, the weights 150 may include two weights (e.g., one corresponding to the first modified image data 130 and one corresponding to the second modified image data 140) for each pixel described in the image data 110. In a particular example, the weights favor a simulated low exposure image (e.g., the first modified image data 130) for pixels corresponding to relatively brighter areas described in the image data 110 and favor a simulated high exposure image (e.g., the second modified image data 140) for pixels corresponding to relatively darker areas described in the image data 110. Generation of the weights 150 is described in more detail below with reference to FIG. 4.

The image refiner 106 may generate refined image data 160 by generating new pixel values based on the sets of modified image data generated by the image modifier 103 (e.g., the first modified image data 130 and the second modified image data 140) and the weights 150. For example, the image refiner 106 may combine the luma channel of the first modified image data 130 with the luma channel of the second modified image data 140 based on the weights 150 to generate new luma channel values for the refined image data 160. The refined image data 160 may describe a refined version of the image described by the image data 110 or may describe a refined portion of the image described by the image data 110. As explained above, the first modified image data 130 may represent a simulated low exposure image with increased contrast in areas corresponding to relatively brighter areas of the input image. The second modified image data 140 may represent a simulated high exposure image with increased contrast in areas corresponding to relatively darker areas of the input image. The weights 150 may favor the first modified image data 130 in areas corresponding to brighter areas of the input image and favor the second modified image data 140 in areas corresponding to relatively brighter areas of the input image. Thus, combining the first modified image data 130 and the second modified image data 140 based on the weights 150 may enable generation of a refined image with enhanced contrast in areas corresponding to both brighter and darker areas of the input image. Objects in the refined image may be more easily detectable and/or discernable by humans and computer vision systems due to the enhanced contrast. Generation of the refined image data 160 is described in more detail below with reference to FIG. 2.

In the example illustrated in FIG. 1, the computing device 102 sends the refined image data 160 to the display device 107. In some examples, the refined image data 160 may be sent to a memory device or to another computing device, such as a computing device that provided the image data 110 as part of an image refining request. In a particular example, the refined image data 160 may be sent to the display device 107 and/or to the other computing device as part of a video stream 170. In a particular example, the refined image data 160 is generated at a rate that enables output of the refined image data 160 at a same rate as the image data 110 is received (e.g., the refined image data 160 may be generated in real-time or near real-time). The video stream 170 may correspond to a 30 frames per second video stream. In alternative examples, the refined image data 160 may be sent to the display device 107 and/or to the other computing device as a still image. In some examples, the refined image represented by the refined image data 160 may correspond to a “dehazed” version of the input image. That is, obscuring effects of various conditions, such as condensate on a capture lens or atmospheric conditions, such as fog, rain, smoke, or haze, may be lessened or absent from the refined image as compared to the input image. In particular examples, the computing device 102 may generate one refined image per input image received.

Thus, the system 100 may receive image data and generate refined image data based on the received image data. The refined image data may describe an image that is clearer than an image described by the image data. Therefore, the system 100 may enable image enhancement that may be used to improve images for use by individuals and computer vision systems.

Referring to FIG. 2, a diagram 200 illustrating generation of a refined image based on an input image is shown. The refined image may be generated by a computing device, such as the computing device 102 of FIG. 1. The diagram 200 depicts an input image 212. The input image 212 may be described by image data, such as the image data 110. The input image 212 includes a plurality of pixels 214-222. While the input image 212 is shown as including 9 pixels, the input image 212 may include more or fewer pixels. For example, the input image 212 may include 1920×1080 pixels. Each of the plurality of pixels 214-222 has one or more associated values (e.g., in a luma channel value, a blue chroma channel value, and a red chroma channel value). In the illustrated example, each of the pixels is shown with an associated luma channel intensity value. The pixel 214 has an intensity value of i₁, the pixel 215 has an intensity value of i₂, the pixel 216 has an intensity value of i₃, the pixel 217 has an intensity value of i₄, the pixel 218 has an intensity value of i₅, the pixel 219 has an intensity value of i₆, the pixel 220 has an intensity value of i₇, the pixel 221 has an intensity value of i₇, the pixel 221 has an intensity value of i₈, and the pixel 222 has an intensity value of i₉.

An image modifier, such as the image modifier 103, may generate modified images based on the input image 212. In the illustrated example, a simulated low exposure image 230 and a simulated high exposure image 241 are generated. In other examples, more or different modified images may be generated. The simulated low exposure image 230 may be described by first modified image data, such as the first modified image data 130. The simulated low exposure image 230 includes pixels 232-240, which correspond to (e.g., are transformed versions of) the pixels 214-222 of the input image 212. Each pixel 232-240 of the simulated low exposure image 230 may be generated by applying a function F to the intensity value of a corresponding pixel 214-222 of the input image 212 to obtain a first modified intensity value. For example, the pixel 232 of the simulated low exposure image 230 may correspond to the pixel 214 in the input image 212 (e.g., have same x-y coordinate position within the simulated low exposure image 230). The function F may receive an input intensity value of a pixel 214-222 of the input image 212 and output an intensity value to be assigned to a corresponding pixel in the simulated low exposure image 230. In particular, the function F may generally output intensity values lower than received intensity values. Thus, a first modified intensity value of the pixel 232 may be obtained by applying the function F to the intensity value of the pixel 214 (e.g., i₁). Accordingly, the first modified intensity value of the pixel 232 may equal F(i₁)=x₁. First modified intensity values of the pixels 233-240 may be generated similarly by applying the function F to the intensity values of the pixels 215-222, as shown. Values of the pixels 232-240 in other channels (e.g., a blue chroma component value, a red chroma component value, etc.) may be equal to the values of the corresponding pixels 214-222. For example, the pixel 214 may have a blue chroma value Cb₁ and a red chroma value Cr₁, and the corresponding pixel 232 may have the blue chroma value Cb₁ and the red chroma value Cr₁. In alternative examples, the function F may generate new blue chroma values and/or alternative red chroma values in addition or in the alternative to new luma channel values. In other examples, the pixels 214-222 may have alternate associated channels (e.g., red, green, and blue) and the function F may generate one or more new values in the alternate associated channels for the pixels 232-240. Contrast in areas of the simulated low exposure image 230 that correspond to relatively brighter areas (e.g., areas with relatively higher average luma values) in the input image 212 may be higher than in the corresponding areas in the input image 212.

The simulated high exposure image 241 may be described by second modified image data, such as the second modified image data 140. The simulated high exposure image 241 includes pixels 242-250, which correspond to (e.g., are transformed versions of) the pixels 214-222 of the input image 212. The simulated high exposure image 241 may be generated by applying a function G to the intensity value of a corresponding pixel 214-222 of the input image 212 to obtain a second modified intensity value. For example, the pixel 242 of the simulated high exposure image 241 may correspond to the pixel 214 in the input image 212 (e.g., have the same x-y coordinate position within the high exposure image 241). The function G may receive an input intensity value of a pixel 214-222 of the input image 212 and output an intensity value to be assigned to a corresponding pixel in the simulated high exposure image 241. In particular, the function G may generally output intensity values higher than received intensity values. Thus, a second modified intensity value of the pixel 242 may be obtained by applying the function G to the intensity value of the pixel 214 (e.g., i₁). Accordingly, the second modified intensity value of the pixel 242 may equal G(i₁)=x₁₀. Second modified intensity values of the pixels 243-250 may be generated similarly by applying the function G to the intensity values of the pixels 215-222, as shown. Values of the pixels 242-250 in other channels (e.g., a blue chroma component value, a red chroma component value, etc.) may be equal to the values of the corresponding pixels 214-222. For example, the pixel 214 may have a blue chroma value Cb₁ and a red chroma value Cr₁, and the corresponding pixel 242 may have the blue chroma value Cb₁ and the red chroma value Cr₁. In alternative examples, the function G may generate new blue chroma values and/or alternative red chroma values in addition or in the alternative to new luma channel values. In other examples, the pixels 214-222 may have alternate associated channels (e.g., red, green, and blue) and the function G may generate one or more new values in the alternate associated channels for the pixels 242-250. Contrast in areas of the simulated high exposure image 241 that correspond to relatively darker areas (e.g., areas with relatively lower average luma values) in the input image 212 may be higher than in the corresponding areas in the input image 212.

A weight calculator, such as the weight calculator 105, may generate weights 251 corresponding to each of the pixels 214-222 for each of the modified images generated (e.g., the simulated low exposure image 230 and the simulated high exposure image 241). The weights 251 may correspond to the weights 150. The sum of the weights for each pixel may equal 1. For example, the weights 251 may include a plurality of sets of weights 252-260. Each of the sets of weights 252-260 may correspond to one of the pixels 214-222. Each of the sets of weights 252-260 may include a value for each modified image generated and a sum of the values may add up to 1. For example, a first set of weights 252 may include a first weight w₁ and a second weight 1−w₁ that correspond to the pixel 214. The first weight w₁ may be associated with the simulated low exposure image 230. In particular, the first weight w₁ may be associated with the pixel 232 of the simulated low exposure image 230. The second weight 1−w₁ may be associated with the simulated high exposure image 241. In particular, the second weight 1−w₁ may be associated with the pixel 242 of the simulated high exposure image 241. The sets of weights 253-260 may each include a weight per modified image (e.g., the simulated low exposure image 230 and the simulated high exposure image 241). In the illustrated example, there may be two weights per set because there are two modified images (e.g., the simulated low exposure image 230 and the simulated high exposure image 241). In other examples that include more modified images, the sum of the weights in a set of weights may add up to 1. In the illustrated example, the weights 251 may favor the simulated low exposure image 230 in areas corresponding to relatively brighter areas of the input image 212, and the weights 251 may favor the simulated high exposure image 241 in areas corresponding to relatively darker areas of the input image 212. Generation of the weights 251 is explained with more detail with reference to FIG. 4.

An image refiner, such as the image refiner 106, may combine the simulated low exposure image 230 and the simulated high exposure image 241 based on the weights 251 to generate the refined image 261. The refined image 261 may be described by refined image data, such as the refined image data 160. The refined image 261 includes pixels 262-270. Values (e.g., intensity values) for each of the pixels 262-270 may be assigned based on a sum of a corresponding pixel from the simulated low exposure image 230 and a corresponding pixel from the simulated high exposure image 241, each weighted based on corresponding weights from the weights 251. For example, a luma channel value for each of the pixels 262-270 in the refined image 261 may be based on a weighted combination of luma channel values of a corresponding pixel 232-240 in the simulated low exposure image 230 and a corresponding pixel 242-250 in the simulated high exposure image 241. To illustrate, the pixel 262 in the refined image 261 may have a luma channel intensity value equal to a combination of the corresponding pixels 232 and 242 weighted by the corresponding set of weights 252 (e.g., x₁w₁+x₁₀(1−w₁)). Thus, each of the pixels 262-270 in the refined image 261 may have one or more values (e.g., a luma channel value) that is based on a weighted combination of one or more values of corresponding pixels in the low exposure image 230 and the high exposure image 241.

As explained above, the simulated low exposure image 230 may have relatively higher contrast in areas corresponding to brighter areas of the input image 212, and the high exposure image 241 may have relatively higher contrast in areas corresponding to darker areas of the input image 212. Since the refined image 261 is generated by combining the simulated low exposure image 230 and the simulated high exposure image 241 using the weights 251 that favor the simulated low exposure image 230 in areas corresponding to relatively brighter areas of the input image 212 and that favor the simulated high exposure image 241 in areas that correspond to relatively darker areas of the input image 212 to generate the refined image 261, the refined image 261 may have higher contrast than the input image 212 in both areas that correspond to relatively bright areas of the input image 212 and areas that correspond to relatively dark areas of the input image 212. Thus, objects may be easier to detect (e.g., by individuals or computer vision systems) in the refined image 261 as compared to the input image 212. Thus, the diagram 200 illustrates how an input image may be refined to clarify objects in the image.

Referring to FIG. 3, a diagram 300 illustrating generation (or identification) of functions used to create modified image data is shown. Functions used to generate modified images may be generated based on an average (e.g., a mean, a median, or a mode) of pixel values (e.g., luma channel values) in the input image. For example, the diagram 300 includes a histogram 302 illustrating a mode 303 (e.g., a most common value) luma channel value for an input image. The diagram 300 further illustrates a graph 304. The graph 304 illustrates a plot of a first function 305 and a plot of a second function 306. The first function 305 may correspond to the function F used to generate the simulated low exposure image 230, and the second function 306 may correspond to the function G used to generate the simulated high exposure image 241. In some examples, one or both of the first function 305 and the second function 306 may be a non-linear function (e.g., may be a polynomial function of a degree greater than one). The horizontal axis of the graph 304 may correspond to luma channel intensity values of pixels in an input image, such as the input image 212. The vertical axis may correspond to luma channel intensity values of pixels in modified images, such as the simulated low exposure image 230 and the simulated high exposure image 241. The mode 303 may be calculated by the following algorithm. Each luma channel value (or range of luma channel values) in the input image 212 may be assigned to a different bin. A value of each bin may be equal to a logarithm of a number of pixels in the input image 212 that have a luma channel value corresponding to the bin. The mode 303 may be equal to a luma channel value corresponding to a bin with a highest value of all of the bins. When a range of luma channel values is assigned to a bin, the luma channel value of the bin may be equal to a particular luma channel value in the range (e.g., an average of the range). In some examples, the mode 303 may correspond to a regularized mode. For example, a regularization function may be applied to the bins before determining which bin has the highest value. To illustrate, λ*(n−n₀)² may be subtracted from each bin, where λ is a normalization constant (e.g., 0.001), n is the luma channel value that corresponds to the bin, and n₀ is a typical luma channel value of the sky (e.g., 200). The regularization function may cause bins relatively closer to the sky value n₀ to be preferred over bins corresponding to darker values.

In a particular example, one or both of the first function 305 and the second function 306 may be determined (e.g., identified) based on the mode 303. The first function 305 may be determined so that output intensity values are lower than input intensity values, as illustrated. In some examples, the first function 305 may approximate a function E(input)=input (e.g., a function for which the output is equal to the input). The second function 306 may be determined so that output intensity values are higher than input intensity values, as illustrated. A derivative of the first function 305, F(y; m), may have a largest value at the mode 303, where m is the mode 303. In a particular example, the first function 305, F(y; m), is defined from F(0; m)=0 to F(1, m)=1 and may be obtained by integrating the derivative of F(y; m), where m is equal to the mode 303. The derivative of F(y; m), F′(y; m), may be equal to

$$\frac{A}{1 + \frac{{( y - m )}^{2}}{{w}^{2}}} ,$$

where w is a user-specified width parameter and A is automatically determined so that F(1; m)=1 or so that an average value of F is 1 in the domain [0, 1]. Chroma values of the pixel values of the input image 212 may be modified based on the first function 305. For example, chroma channel values U in the input image 212 may be changed to U′ in the simulated low exposure image 230 based on the equation

$${U}^{′} = U * \frac{F ( y ; m ) - F ( m ; m )}{y - m} .$$

Similarly, chroma channel values V in the input image 212 may be changed to V′ in the simulated low exposure image 230 based on the equation

$${V}^{′} = V * \frac{F ( y ; m ) - F ( m ; m )}{y - m} .$$

The second function 306 may be a piecewise-sigmoid function defined as

$$G ( y ) = \frac{1}{1 + {e}^{\frac{- ( y - t )}{{w}_{1}}}}$$

when y<t and

$$G ( y ) = \frac{1}{1 + {e}^{\frac{- ( y - t )}{{w}_{2}}}}$$

when y>t, where t, w₁, and w₂ are threshold and width parameters that may be selected by a user. Chroma values of the pixel values of the input image 212 may be modified based on the second function 306.

In particular examples, the mode 303 and the functions 305, 306 may be determined by an image modifier, such as the image modifier 103. For example, the image modifier 103 may receive the image data 110 and determine the mode 303 based on values (e.g., luma channel values) of the pixels described by the image data 110. The image modifier 103 may determine the functions 305, 306 based on the mode 303. The mode 303 and the functions 305, 306 may be determined for each input image and may differ between each input image. For example, the mode 303 and the functions 305, 306 may be determined for each frame in an input video stream. In particular examples, the functions 305, 306 may correspond to lookup tables. For example, a first lookup table 310 may correspond to the first function 305 and a second lookup table 312 may correspond to the second function 306. In some examples, more than 2 functions are generated so that more than 2 modified images may be used to generate a refined image.

The mode 303 may be indicative of a luma channel value that corresponds to a distortion in an image due to various conditions affecting quality of the input image. For example, pixels affected by haze in the atmosphere may all have a similar luma channel value. In some examples, an adjusted mode is used to select the first function 305 and the second function 306. For example, the mode 303 may be shifted toward an expected mode (e.g., a value of 200). To illustrate, when the mode 303 is more than a threshold amount different than the expected mode, an adjusted mode may be generated by adding or subtracting a value to the mode 303 to move the adjusted mode toward the expected mode. The adjusted mode may be used instead of the mode 303 to generate the functions 305, 306.

Thus, FIG. 3 illustrates how a luma channel value indicative of a distortion (e.g., haze) may be used to select functions that may be used to generate modified images used in generating a refined image.

Referring to FIG. 4, a diagram 400 illustrating generation of the weights 251 is shown. In particular, the diagram illustrates how a weight calculator, such as the weight calculator 105, may generate the set of weights 256 based on the input image 212. The weights 251 may be generated based on the luma channel intensity values of the input image 212. In particular, a set of weights corresponding to a particular pixel may be based on an average of the luma channel intensity values that surround the particular pixel. A first weight associated with the particular pixel may be calculated by computing an average luma intensity of pixels around the particular pixel(e.g., within a radius of 3% of a width of the input image 212). The average may or may not include be based on a luma intensity of the particular pixel. A second weight associated with the particular pixel may be equal to 1 minus the first weight. The weight calculator 105 may apply a soft threshold to the weights using a sigmoid function. For example, average luma values much greater than a value (e.g., 0.5) may produce a weight of approximately 1 while average luma values much less than the value may produce a weight of approximately 0. The weight calculator 105 may produce continuous intermediate values for average luma values relatively close to the value.

For example, the set of weights 256 corresponding to the pixel 218 may be calculated based on an average of the luma channel intensity values of pixels that surround (e.g., a cluster of pixels) the pixel 218 (e.g., the pixels 214-222). In the example, shown in FIGS. 1 and 2 where two modified images are generated, a weight associated with the first function (e.g., the function F used to generate the simulated low exposure image 230) may be equal to the average of the luma channel intensity values that surround the particular pixel, and the weight associated with the second function (e.g., the function G used to generate the simulated high exposure image 241) may be equal to one minus the average. Similarly, weights associated with the pixels 214-217 and the pixels 219-222 may be generated based on averages of the luma channel intensity values of pixels surrounding those pixels.

The weights may cause a simulated low exposure image to be considered more (e.g., to be more heavily weighted) in determining a value of pixels in a refined image corresponding to bright regions of the input image while causing a simulated high exposure image to be considered more (e.g., to be more heavily weighted) in determining a value of pixels in the refined image corresponding to dark regions of the input image. For example, the first set of weights 252 may cause the image refiner 106 to consider the pixel 232 in the simulated low exposure image 230 more than the pixel 242 in the simulated high exposure image 241 when the pixel 214 is in a bright region of the input image 212. Similarly, the first set of weights 252 may cause the image refiner 106 to consider the pixel 242 in the simulated high exposure image 241 more than the pixel 232 in the simulated low exposure image 230 when the pixel 214 is in a dark region of the input image 212. More weights may be generated for a particular pixel when more modified images are used to generate a refined image. The sum of the weights corresponding to a particular pixel may be 1.

Thus, FIG. 4 illustrates how weights may be generated that may be used to combine images to generate a refined image. The refined image may have increased contrast relative to an input image in both bright and dark areas because the weights may cause modified images with higher contrast in darker areas (e.g., the simulated high exposure image 241) to be considered more in generation of dark areas of the refined image and modified images with higher contrast in brighter areas (e.g., the simulated low exposure image 230) to be considered more in generation of bright areas of the refined image. Therefore, the weights generated as shown in FIG. 4 may be used to generate a refined image in which objects are more easily detectable for individuals and computer vision systems.

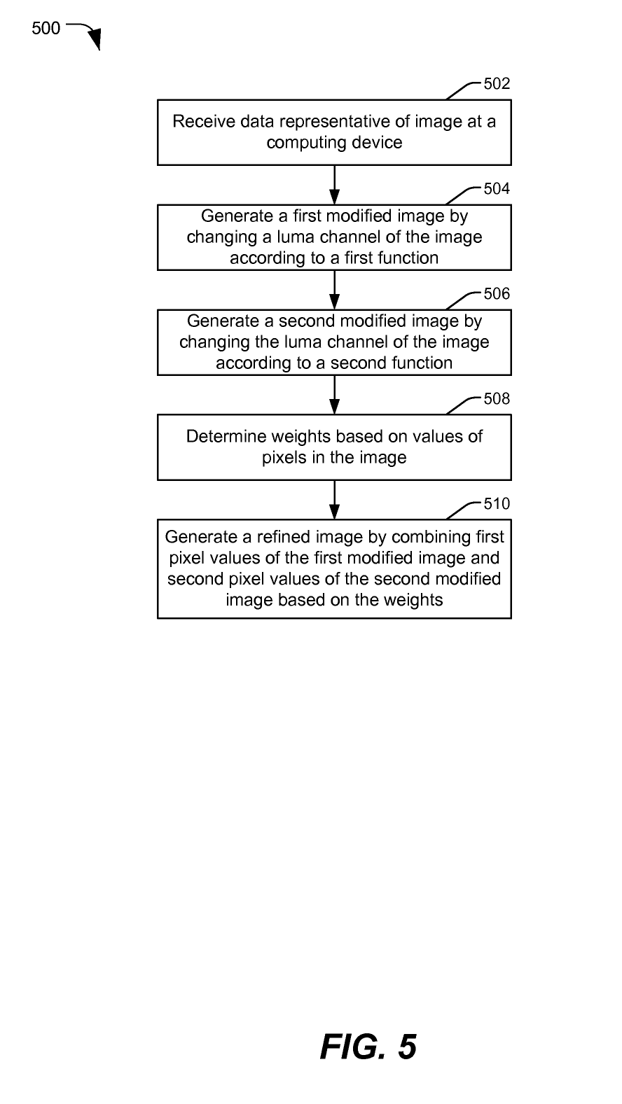

Referring to FIG. 5, a flowchart illustrating a method 500 of generating a refined image is shown. The method 500 includes receiving data representative of image at a computing device, at 502. For example, the computing device 102 may receive the image data 110 from the image sensor 104 or from another computing device. The image data 110 may represent an image of a scene. The method 500 further includes generating a first modified image by changing a luma channel of the image according to a first function, at 504. For example, the image modifier 103 may generate the first modified image data 130 based on the image data 110. The first modified image data 130 may describe a simulated low exposure image, such as the simulated low exposure image 230. The image modifier 103 may generate the first modified image data 130 by modifying a luma channel of the input image represented by the image data 110 according to a first function (e.g., the first function 305). The method 500 further includes generating a second modified image by changing the luma channel of the image according to a second function, at 506. For example, the image modifier 103 may generate the second modified image data 140. The second modified image data 140 may describe a simulated high exposure image, such as the simulated high exposure image 241. The image modifier 103 may generate the second modified image data 140 by modifying the luma channel of the input image represented by the image data 110 according to a second function (e.g., the second function 306). The method 500 further includes determining weights based on values of pixels in the image, at 508. For example, the weight calculator 105 may generate the weights 150 based on pixel values of the input image described by the image data 110. The method 500 further includes generating a refined image by combining first pixel values of the first modified image and second pixel values of the second modified image based on the weights, at 510. For example, the image refiner 106 may combine the first modified image represented by the first modified image data 130 and the second modified image represented by the second modified image data 140 based on the weights 150 to generate the refined image represented by the refined image data 160.

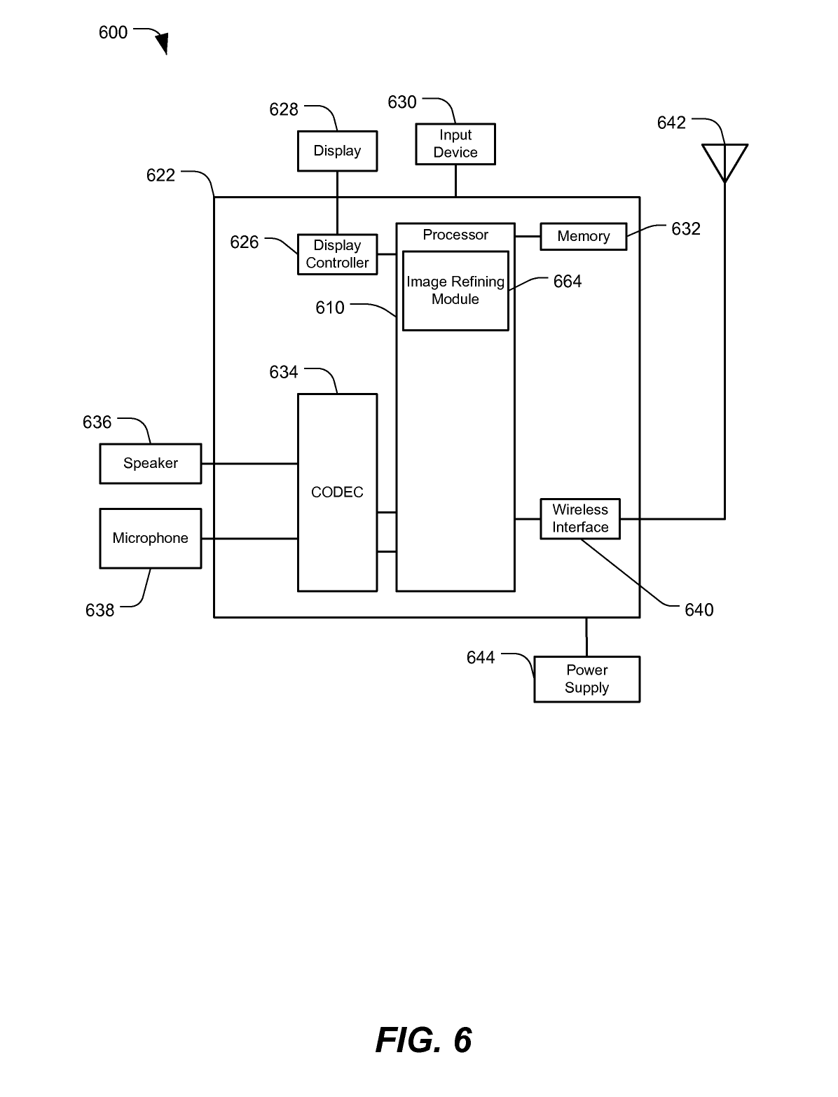

Referring to FIG. 6, a block diagram of a particular illustrative aspect of a device 600 (e.g., an electronic device) is depicted. The device 600 may correspond to the computing device 102. The device 600 includes a processor 610 coupled to a memory 632. The processor 610 may execute software, include hardware, or a combination thereof corresponding to an image refining module 664. The image refining module 664 may correspond to the image modifier 103, the weight calculator 105, and the image refiner 106.

The memory 632 may include data and instructions, such as computer-readable instructions or processor-readable instructions. The data and instructions may be associated with executing the image refining module 664.

FIG. 6 also shows a display controller 626 that is coupled to the processor 610 and to a display 628. A coder/decoder (CODEC) 634 can also be coupled to the processor 610. A speaker 636 and a microphone 638 can be coupled to the CODEC 634. The display 628 may correspond to the display device 107.

FIG. 6 also includes a camera 631. The camera 631 may correspond to the image sensor 104. The camera 631 may be physically coupled to the device 600 or may communicate with the device 600 wirelessly.

FIG. 6 also indicates that a wireless interface 640 can be coupled to the processor 610 and to an antenna 642. The device 600 may communicate with other devices. In some implementations, the processor 610, the display controller 626, the memory 632, the CODEC 634, and the wireless interface 640 are included in a system-in-package or system-on-chip device 622.

In a particular aspect, an input device 630 and a power supply 644 are coupled to the system-on-chip device 622. Moreover, in a particular aspect, as illustrated in FIG. 6, the display 628, the input device 630, the speaker 636, the microphone 638, the antenna 642, and the power supply 644 are external to the system-on-chip device 622. However, each of the display 628, the input device 630, the speaker 636, the microphone 638, the antenna 642, and the power supply 644 can be coupled to a component of the system-on-chip device 622, such as an interface or a controller. Although the image refining module 664 is depicted as being included in the processor 610, in other implementations, the image refining module 664 may be included in another component of the device 600 or a component coupled to the device 600.

In an aspect, an apparatus includes means for receiving data representative of image at a computing device. The means for receiving data may correspond to the image sensor 104, the camera 631, the computing device 102, the device 600, the antenna 642, the wireless interface 640, the memory 632, or a combination thereof. The apparatus further includes means for generating a first modified image by changing a luma channel of the image according to a first function. The means for generating first modified image may correspond to the computing device 102, the image modifier 103, the device 600, the processor 610, the image refining module 664, or to a combination thereof. The apparatus further includes means for generating a second modified image by changing the luma channel of the image according to a second function. The means for generating a second modified image may correspond to the computing device 102, the image modifier 103, the device 600, the processor 610, the image refining module 664, or to a combination thereof. The apparatus further includes means for determining weights based on values of pixels in the image. The means for determining weights may correspond to the computing device 102, the weight calculator 105, the device 600, the processor 610, the image refining module 664, or to a combination thereof. The apparatus further includes means for generating a refined image by combining first pixel values of the first modified image and second pixel values of the second modified image based on the weights. The means for generating a refined image may correspond to the computing device 102, the image refiner 106, the device 600, the processor 610, the image refining module 664, or to a combination thereof.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A method of image processing comprising:
receiving data representative of an image at a computing device;
generating a first modified image by changing a luma channel of the image according to a first function;
generating a second modified image by changing the luma channel of the image according to a second function;
determining weights based on values of pixels in the image; and
generating a refined image by combining first pixel values of the first modified image and second pixel values of the second modified image based on the weights.

2. The method of claim 1, wherein the first function and the second function are non-linear.

3. The method of claim 1, further comprising determining a most common value of intensity values of pixels in the image, wherein the first function and the second function are identified based on the most common value.

4. The method of claim 1, wherein the first function and the second function correspond to lookup tables.

5. The method of claim 1, wherein the image is of a scene, wherein the first modified image includes a simulated low exposure image of the scene, and wherein the second modified image includes a simulated high exposure image of the scene.

6. The method of claim 1, wherein the weights include a first weight and a second weight, and wherein generating the refined image includes assigning an intensity value to each pixel in the refined image, wherein the assigned intensity value for each pixel is determined by adding a product of the first weight and a first intensity value of a pixel in the first modified image to a product of the second weight and a second intensity value of a pixel in the second modified image.

7. The method of claim 1, wherein each of the weights is generated based on an average intensity value of a corresponding cluster of pixels from the image.

8. The method of claim 1, wherein each pixel of the first modified image has a luma channel value based on an output of the first function applied to a luma channel value of a corresponding pixel in the image, and wherein each pixel of the second modified image has a luma channel value based on an output of the second function applied to luma channel value of a corresponding pixel in the image.

9. The method of claim 1, further comprising sending the refined image to a display.

10. The method of claim 9 further comprising sending to a display the refined image as part of video stream.

11. A computer readable storage device storing instructions that, when executed by a processor, cause the processor to perform operations including:
receiving data representative of image;
generating a first modified image by changing a luma channel of the image according to a first function;
generating a second modified image by changing the luma channel of the image according to a second function;
determining weights based on values of pixels in the image; and
generating a refined image by combining first pixel values of the first modified image and second pixel values of the second modified image based on the weights.

12. The computer readable storage device of claim 11, wherein the refined image includes a dehazed version of the image.

13. The computer readable storage device of claim 11, wherein the operations further include determining a most common value of intensity values of pixels in the image, wherein the first function and the second function are identified based on the most common value.

14. The computer readable storage device of claim 11, wherein the first function and the second function are represented by lookup tables.

15. The computer readable storage device of claim 11, wherein the image is of a scene, wherein the first modified image includes a simulated low exposure image of the scene, and wherein the second modified image includes a simulated high exposure image of the scene.

16. The computer readable storage device of claim 11, wherein generating the refined image includes assigning an intensity value to each pixel in the refined image, wherein the assigned intensity value for each pixel is determined by adding a first intensity value of a pixel in the first modified image and a second intensity value of a pixel in the second modified image based on one or more of the weights.

17. The computer readable storage device of claim 11, wherein each of the weights is generated based on an average intensity value of a corresponding cluster of pixels from the image.

18. The computer readable storage device of claim 11, wherein each of the image, the first modified image, the second modified image, and the refined image has a same number of pixels.

19. The computer readable storage device of claim 11, further comprising sending the refined image to a display.

20. The computer readable storage device of claim 11, wherein the operations further include sending to a display the refined image as part of a video stream.

21. An apparatus comprising:
a memory; and
a processor configured to:
receive data representative of image at a computing device;
generate a first modified image by changing a luma channel of the image according to a first function;
generate a second modified image by changing the luma channel of the image according to a second function;
determine weights based on values of pixels in the image; and
generate a refined image by combining first pixel values of the first modified image and second pixel values of the second modified image based on the weights.

22. The apparatus of claim 21, wherein the first function and the second function are non-linear.

23. The apparatus of claim 21, wherein the processor is further configured to determine a most common value of intensity values of pixels in the image, wherein the first function and the second function are identified based on the most common value.

24. The apparatus of claim 21, wherein the first function and the second function are represented by lookup tables.

25. The apparatus of claim 21, wherein the image is of a scene, wherein the first modified image includes a simulated low exposure image of the scene, and wherein the second modified image includes a simulated high exposure image of the scene.

26. The apparatus of claim 21, wherein generating the refined image includes assigning an intensity value to each pixel in the refined image, wherein the assigned intensity value for each pixel is determined by adding a first intensity value of a pixel in the first modified image and a second intensity value of a pixel in the second modified image based on one or more of the weights.

27. The apparatus of claim 21, wherein each of the weights is generated based on an average intensity value of a cluster of pixels described by the image.

28. The apparatus of claim 21, wherein each of the image, the first modified image, the second modified image, and the refined image has a same number of pixels.

29. The apparatus of claim 21, wherein the processor is further configured to send the refined image to a display.

30. An apparatus comprising:
means for receiving data representative of image at a computing device;
means for generating a first modified image by changing a luma channel of the image according to a first function;
means for generating a second modified image by changing the luma channel of the image according to a second function;
means for determining weights based on values of pixels in the image; and
means for generating a refined image by combining first pixel values of the first modified image and second pixel values of the second modified image based on the weights.
